(19) United States
(12) Patent Application Publication
(10) Pub. No.: US 2013/0212124 A1
(43) Pub. Date: Aug. 15, 2013

(54) INFORMATION PROCESSING APPARATUS AND CONTROL METHOD THEREOF

(71) Applicant: CANON KABUSHIKI KAISHA, (US)

(72) Inventor: Masanori Fukada, Tokyo (JP)

(73) Assignee: CANON KABUSHIKI KAISHA, Tokyo (JP)

(21) Appl. No.: 13/747,178

(22) Filed: Jan. 22, 2013

(30) Foreign Application Priority Data
Feb. 13, 2012 (JP) 2012-028860

(51) Int. Cl. G06F 17/30

(52) U.S. Cl. CPC G06F 17/30477
USPC 707/769

(57) ABSTRACT

A search control unit conducts a search process of data registered in logically one search table by an internal memory table allocated on an internal memory and an external memory table allocated on an external memory. An internal memory retrieving unit conducts a search process of data registered in the internal memory table. An external memory retrieving unit conducts a search process of data registered in the external memory table. The search control unit executes the search process by the internal memory retrieving unit and the search process by the external memory retrieving unit in parallel or sequentially according to a requested search mode.

### BACKGROUND OF THE INVENTION

1. Field of the Invention

The present invention relates to an information process for executing a search process of data registered in a search table.

2. Description of the Related Art

In recent years, not only a general-purpose computer (PC) but also a computer embedded equipment is required to execute a network protocol process at high speed. However, achievement of a sufficient processing speed of GigaBit Ethernet® is far superior to the performance of a processor included in the computer embedded equipment.

Hence, it is generalized to implement broadband network communications by appending an auxiliary device specialized to a protocol process such as TOE (TCP/IP Offload Engine) without using any processor. As characteristic processes of the protocol process of TCP/IP (Transmission Control Protocol/Internet Protocol), a socket retrieve and listen state retrieve are known. Also, an SPD (Security Policy Database) retrieve and SAD (Security Association Database) retrieve in IPsec (security architecture for Internet Protocol) are known. Furthermore, a reassembly retrieve in an IP process is also known, and retrieves for various use purposes have to be executed.

A method of speeding up the search process in the protocol process using a CAM (Content-Addressable Memory) so as to speed up transmission and reception processes based on TCP/IP is known. However, since an associative memory using the CAM is expensive, an associative memory of a method of outputting sequential comparison results using a RAM (Random Access Memory) is used as a substitute of the former memory. A search process using a search apparatus acquires a corresponding address from the search apparatus using a retrieval key, and makes data read and write accesses using the acquired address.

Along with enhancement of the network scale, an upper limit of the number of entries such as socket, SP (Security Policy), and SA (Security Association) is required to be increased. However, the capacity of the associative memory has to be increased in proportion to an increase in upper limit of the number of entries, resulting in an increase in implementation cost. Hence, the search table is partially stored in an external memory such as a DRAM (Dynamic RAM), and the search table stored in an internal memory such as an on-chip SRAM (Static RAM) and that stored in the external memory are logically combined to configure one search table, thus executing the search process. In this manner, a method of increasing the number of entries of search target data while suppressing an increase in memory implementation cost is available. However, accesses to the external memory take much time, and a search for data registered in the external memory consequently takes much time.

In order to execute the efficient search process, a technique for executing a search process while separating a job for executing a search process for the external memory (to be referred to as an external memory search process) and that for executing a search process for the internal memory (to be referred to as an internal memory search process), and reducing a delay time given to a job which executes another search process has been proposed. This technique further proposes a method which efficiently processes a search request of continuous packets by swapping an entry which hits in the external memory search process by an arbitrary entry in the internal memory in case of a single hit mode in which a search is terminated if at least one entry data hits a retrieval key.

In the search for continuous packets in the protocol process, identical entries hit with a high possibility. The search process in the protocol process includes the aforementioned single hit mode, and a global search mode in which all entries and a retrieval key are compared to select all hit entries.

The aforementioned technique attempts to efficiently process a search request of continuous packets by swapping a hit entry in the external memory search process by an arbitrary entry in the internal memory in the single hit mode. However, in case of the single hit mode, when all jobs are executed while being classified into the internal and external memory search processes, a hit rate in the internal memory search process is high, and a process for terminating the external memory search process is required upon hitting in the internal memory search process. As a result, the efficient search process cannot always be executed.

Furthermore, in order to terminate a corresponding job in an external memory search job queue at the time of termination of a job of the internal memory search process in a search job queue, complicated processes and an increase in circuit scale are required, and power consumption is also increased.

### SUMMARY OF THE INVENTION

In one aspect, an information processing apparatus for conducting a search process of data registered in logically one search table configured by an internal memory table allocated on an internal memory of the apparatus and an external memory table allocated on an external memory outside the apparatus, the apparatus comprising: a first retrieving section configured to conduct a search process of data registered in the internal memory table; a second retrieving section configured to conduct a search process of data registered in the external memory table; and a controller configured to execute the search process by the first retrieving section and the search process by the second retrieving section in parallel or sequentially based on whether a search mode is a first search mode or a second search mode. The search process in the first search mode is terminated in a case where one data is detected from the search table, and the search process in the second search mode is continued even after one data is detected from the search table.

According to the aspect, a search process performance can be prevented from dropping when one search table is logically configured using an internal memory and external memory.

Further features of the present invention will become apparent from the following description of exemplary embodiments with reference to the attached drawings.

### BRIEF DESCRIPTION OF THE DRAWINGS

FIG. 1 is a block diagram for explaining the arrangement of a computer according to an embodiment.

FIG. 2 is a block diagram for explaining the arrangement of a communication unit.

FIG. 3 is a view for explaining roles of sub-processors.

FIG. 4 is a block diagram for explaining the arrangement of a retrieving unit.

FIG. 5 is a flowchart for explaining a search process of the retrieving unit.

FIG. 6 is a flowchart for explaining a single hit mode retrieve process.

FIG. 7 is a flowchart for explaining a swapping process of search table entries.

FIG. 8 is a flowchart for explaining a global search mode retrieve process.

FIG. 9 is a flowchart for explaining a registration process.

FIG. 10 is a flowchart for explaining a deletion process.

### DESCRIPTION OF THE EMBODIMENTS

An information process according to an embodiment of the present invention will be described in detail below with reference to the accompanying drawings.

[Arrangement of Apparatus]

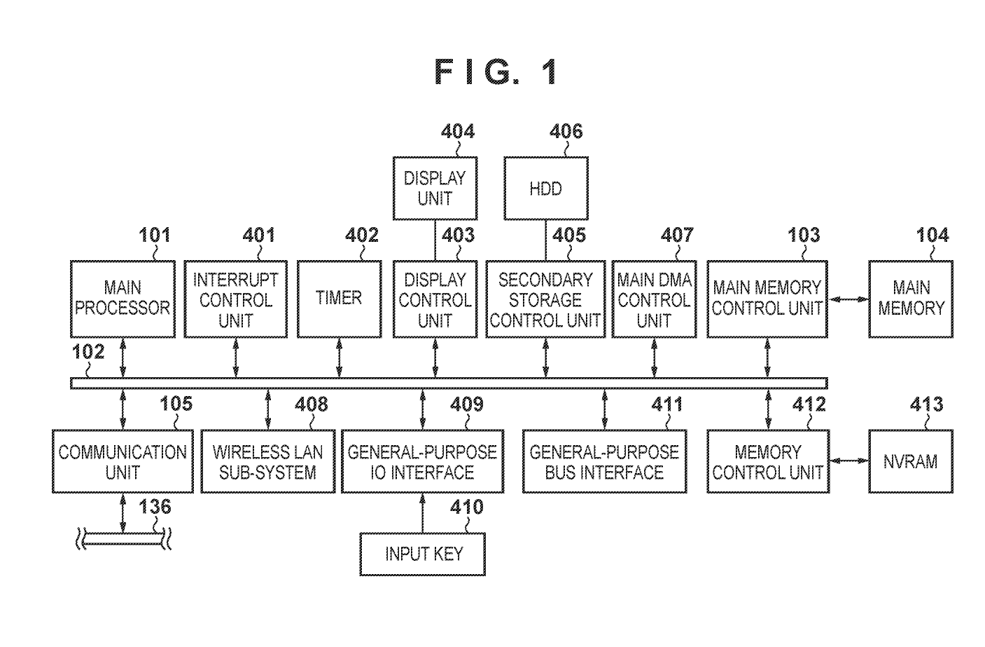

The arrangement of a computer according to an embodiment will be described below with reference to the block diagram shown in FIG. 1. Note that the computer shown in FIG. 1 is an example of a computer embedded equipment.

A main processor 101 of the computer shown in FIG. 1 is connected to respective units (to be described later) via a system bus 102. Note that the system bus 102 is an on-chip bus having a crossover switch structure represented by the AMBA 3.0 AXI (Advanced eXtensible Interface) specification introduced by ARM®, England. The system bus 102 can perform parallel transfer operations of transmission/reception data required for the computer.

An interrupt control unit 401 transfers interrupt events from respective units and a communication unit 105 to the main processor 101. A timer 402 is launched by software or the like to measure a time and to generate a time-out event. An input key 410 connected to a general-purpose IO (Input/Output) interface 409 is an input unit used to set an operation mode of the computer and to input various communication parameters represented by an IP address. A display unit 404 connected to a display control unit 403 is a monitor which displays statuses, setting contents, and the like of the computer.

An HDD (Hard Disk Drive) 406 connected to a secondary storage control unit 405 stores software programs and related data required to implement functions of the computer, firmware programs and related data to be executed by sub-processors of respective sub-systems, and the like. The HDD 406 further stores history information such as operation histories and communication histories of the computer. Note that the software programs required to implement the functions of the computer include an OS (Operating System), application programs and application protocols required to implement the respective functions of the computer, device drivers required to control peripheral devices, and the like.

A main memory 104 connected to a main memory control unit 103 is a RAM, and functions as a work memory of the main processor. That is, the main processor 101 loads the software programs stored in the HDD 406 onto the main memory 104, and executes the OS and application programs.

An NVRAM 413 connected to a memory control unit 412 is a rewritable nonvolatile memory, and stores a boot program which runs at the activation timing of the computer, parameters required to set an initial state of the computer, and the like. The NVRAM 413 further stores device drivers required to control the respective units at the activation timing of the computer, parameters required to be set at the activation timings of the respective units, and the like.

A communication unit 105 connects the computer to a wired network 136. A wireless LAN sub-system 408 connects the computer to a wireless network compliant with the IEEE802.11a/b/g/n standard. A general-purpose bus interface 411 connects the computer to a serial bus such as USB (Universal Serial Bus) or IEEE1394. Note that as will be described later, the communication unit 105 functions as a TOE sub-system (information processing apparatus) which executes a protocol process such as a search process in response to a search request of packets using a packet information process search table.

When a power supply of the computer is turned on, the main processor 101 executes the boot program stored in the NVRAM 413 to initialize the aforementioned units. Then, the main processor 101 loads the software programs stored in the HDD 406 onto the main memory 104 to execute the OS and application programs. Upon initialization of sub-systems, the main processor 101 loads firmware programs to be respectively executed by a plurality of sub-systems (to be described later) incorporated in the communication unit 105 onto the main memory 104 to activate respective sub-processors. The respective sub-processors load the corresponding firmware programs loaded onto the main memory 104 onto their internal instruction cache memories, and execute the firmware programs.

[Communication Unit]

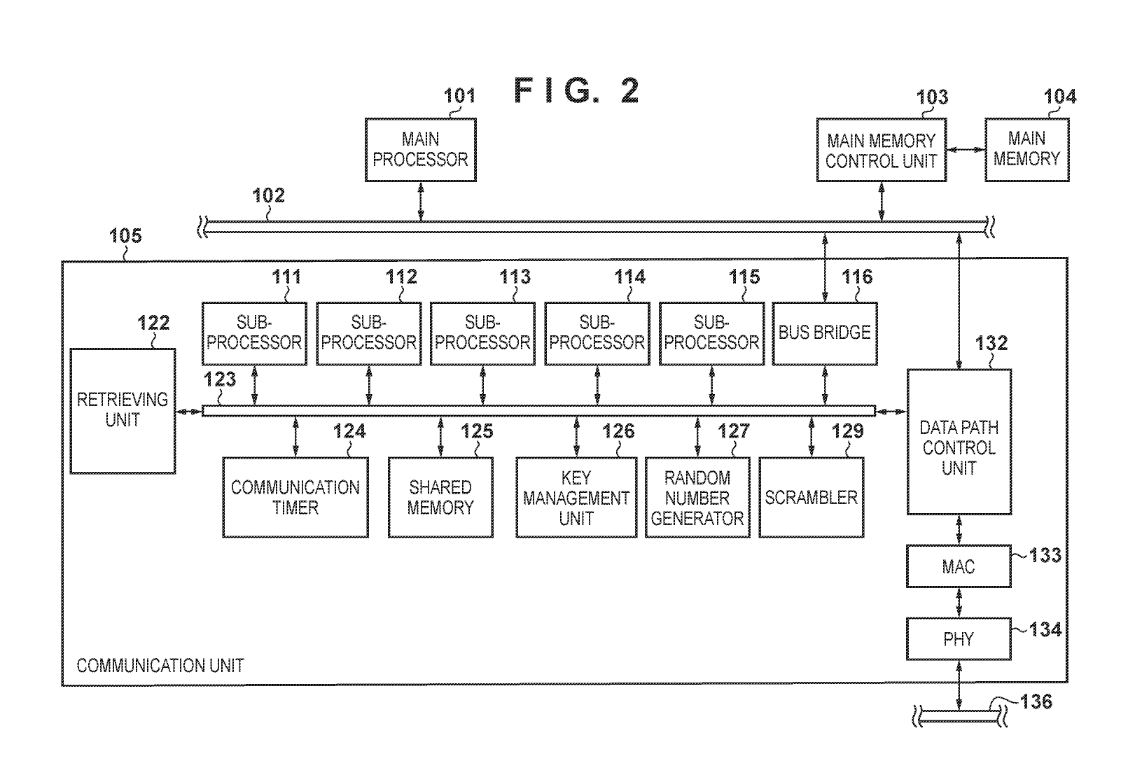

The arrangement of the communication unit 105 will be described below with reference to the block diagram shown in FIG. 2.

A bus bridge 116 connects a sub-system bus 123 as an internal bus of the communication unit 105 and the system bus 102. Note that the sub-system bus 123 has a crossover switch structure. The communication unit 105 incorporates, for example, five sub-processors 111 to 115, and executes TCP/IP protocol processes offloaded from a main system at high speed by multiprocessor processes of these sub-processors. A shared memory 125 is a memory required for communications and information sharing among the sub-processors 111 to 115. A communication timer 124 makes time measurement required for the protocol processes, and generates a time-out event.

The communication unit 105 includes a PHY 134 and MAC (Media Access Controller) 133 as hardware components required to connect the wired network 136. The PHY 134 handles protocol processes and electrical signals of a physical layer (first layer) of an OSI (Open Systems Interconnection) reference model. The MAC 133 processes protocols of a MAC layer corresponding to a lower sub-layer of a data link layer (second layer) of the OSI reference model.

A data path control unit 132 has a DMA (Direct Memory Access)-transfer function of reception packet data and transmission packet data between the main memory 104 or shared memory 125 and the MAC 133. The data path control unit 132 makes check sum calculations of packet data during a transfer process. A retrieving unit 122 is an information processing apparatus (computer apparatus) which has an associative memory, and executes storage of various kinds of management information and search processes of the protocol processes in response to requests from the sub-processors.

The communication unit 105 executes encryption communication protocol (IPsec, SSL (Secure Socket Layer), TLS (Transport Layer Security), and the like) processes, and has a key management unit 126, random number generator 127, and scrambler 129. The key management unit 126 securely holds a generated encryption key, random number, and prime. The random number generator 127 generates a random number required for an encryption process. The scrambler 129 is an AES (Advanced Encryption Standard) scrambler, and further generates a hash function such as SHA (Secure Hash Algorithm; for example, SHA-1) used in authentication, digital signature, and the like, or MDA (Message Digest Algorithm; for example, MD5) standardized as RFC1321.

Sub-Processor

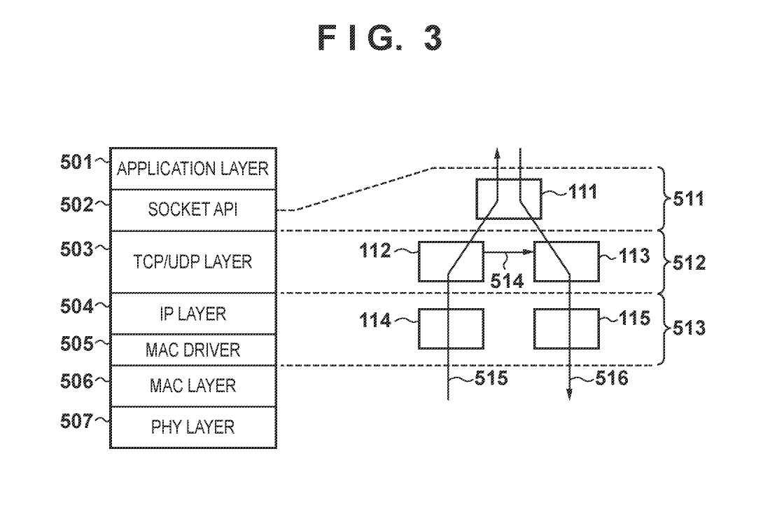

Roles of the sub-processors 111 to 115 of the communication unit 105 will be described below with reference to FIG. 3. The TCP/IP protocol processes have a hierarchical structure of an application layer 501, socket API 502, transport layer (TCP/UDP layer) 503, Internet layer (IP layer) 504, MAC driver 505, MAC layer 506, and PHY layer 507.

The communication unit 105 has a processing function of the IP layer 504 for processing the IP (Internet Protocol), and that of the TCP/UDP layer 503 for processing the TCP (Transfer Control Protocol) and UDP (User Datagram Protocol). Furthermore, the communication unit 105 has a function of the MAC driver 505 for exchanging communication data and communication information with the MAC layer 506, and a partial function of the socket API 502 as an interface of an application communication. The communication unit 105 processes these functions by distributing them to the respective sub-processors.

For example, the communication unit 105 assigns the process of the socket API 502 to the sub-processor 111. The communication unit 105 assigns a process associated with a reception operation 515 of the TCP and UDP processes to the sub-processor 112, and assigns that associated with a transmission operation 516 to the sub-processor 113. The communication unit 105 assigns a process associated with the reception operation 515 of the MAC driver 505 and the IP process to the sub-processor 114, and that associated with the transmission operation 516 to the sub-processor 115. The reason why the processes are distributed in this way is to execute pipeline operations by dividing a series of protocol processes into three pipeline stages 511 to 513. Since the transmission operation 516 and reception operation 515 are separated, the sub-processors which share the respective functions are operated in parallel.

Transmission of processing data and sharing of control information between the sub-processors are attained via the shared memory 125. For example, the TCP transmits delivery acknowledgement information as an acknowledgement response from the receiving side to the transmitting side in terms of the guaranteed delivery of transfer data. That is, in order to make an acknowledgement response, transmission 514 of delivery acknowledgement information is required between the sub-processors 112 and 113. Such transmission of the TCP control information is attained via the shared memory 125. Note that transmission of the delivery acknowledgement information and sharing of the control information between the sub-processors may be attained using the main memory 104.

Retrieving Unit

The sub-processor requests the retrieving unit 122 to execute the search process in the protocol processes, and supplies parameters indicating a process type and the like to the retrieving unit 122 together with a processing request. The type of the search process includes a single hit mode retrieve as a first search mode, a global search mode retrieve as a second search mode, data registration, and data deletion. Also, parameters associated with the search process includes a search mode, retrieval key, data to be registered or deleted, and the like.

Upon reception of a data search request, the retrieving unit 122 executes a data search process by read-out and comparison processes, and returns a search result to the sub-processor as a request source. The search mode includes the single hit mode and global search mode, as described above. Note that in the global search mode, a plurality of entry data may hit at a high possibility.

Upon reception of a data registration request, the retrieving unit 122 registers data included in the parameters in the search table. Upon reception of a data deletion request, the retrieving unit 122 deletes entry data corresponding to data included in the parameters from the search table.

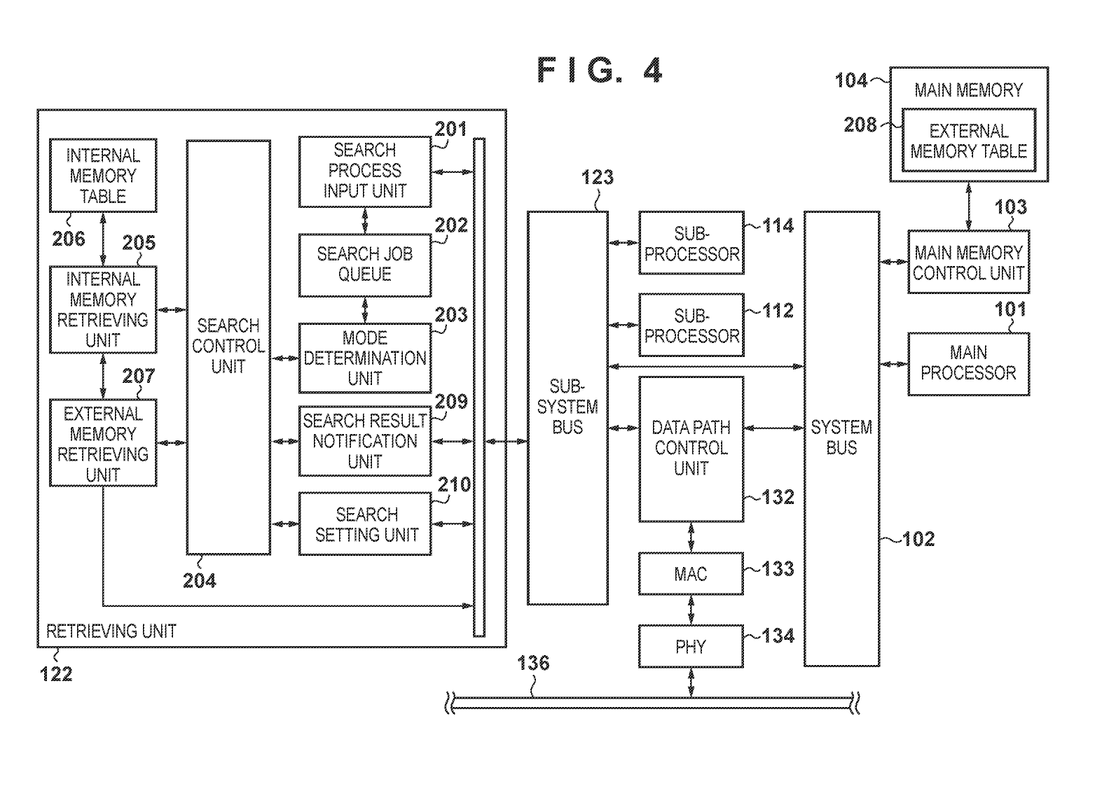

The arrangement of the retrieving unit 122 will be described below with reference to the block diagram shown in FIG. 4. A search process input unit 201 inputs a processing request from the sub-processor. A search job queue 202 functions as a queuing unit of jobs corresponding to processing requests input by the search process input unit 201. Note that the retrieving unit 122 may execute jobs corresponding to processing requests one by one without queuing them.

A mode determination unit 203 analyzes a job to determine the aforementioned type of the search process. A search control unit 204 controls execution of the search process of the determined type. That is, the mode determination unit 203 dequeues a search job from the search job queue 202 in accordance with an instruction from the search control unit 204, determines the contents of the search job, and passes parameters such as a search mode, retrieval key, and data to the search control unit 204.

An internal memory table 206 is allocated in an internal memory of the retrieving unit 122, and stores entry data as search targets. Note that the internal memory table 206 may be allocated in the shared memory 125 in place of the internal memory. An internal memory retrieving unit 205 is a first retrieving unit which executes a series of search processes for executing a search process to the internal memory, reading out entry data from the internal memory table 206, and comparing the readout entry data with a retrieval key.

An external memory table 208 stores entry data as search targets. The external memory table 208 is assigned to, for example, a predetermined area on the main memory 104. An external memory retrieving unit 207 is a second retrieving unit which executes a series of search processes for executing a search process to the external memory table 208, reading out entry data from the external memory table 208, and comparing the readout entry data with a retrieval key.

That is, a packet information process search table is configured by a combination of the internal memory table 206 and external memory table 208. In the search processes of the packet information process search table, an access to the internal memory table 206 is faster than that to the external memory table 208.

A series of operations of the search processes are executed by the internal memory retrieving unit 205 and external memory retrieving unit 207. However, when internal and external memory search processes are executable in parallel, one unit which executes both the processes may execute the series of operations of the search processes, or a plurality of units may be arranged. Alternatively, one unit may time-divisionally execute the internal and external memory search processes.

The search control unit 204 notifies the sub-processor as a request source of the search processes of a search result via a search result notification unit 209. Furthermore, a search setting unit 210 functions as a unit which gives setting information to the retrieving unit 122. That is, at the time of initialization of the retrieving unit 122, the main processor 101 executes a process for setting the maximum number of entries, an address space of the main memory 104 which holds the external memory table 208, and the like with respect to the search setting unit 210. Note that the arrangement example which allows to flexibly set the number of entries and the address space of the external memory table by software has been explained. Alternatively, the number of entries and the address space of the external memory table may be fixed in advance.

[Search Process]

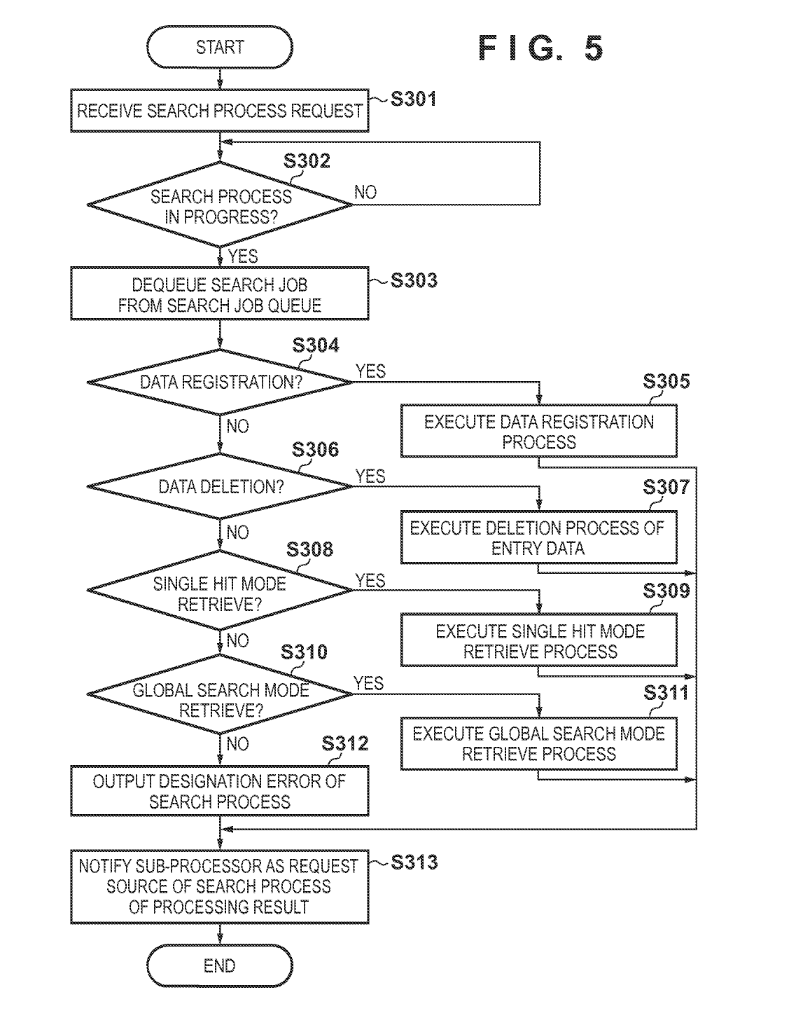

The search processes of the retrieving unit 122 will be described below with reference to the flowchart shown in FIG. 5.

When the sub-processor writes a search process request in a predetermined register, the search process input unit 201 inputs the search process request, and queues a corresponding search job in the search job queue 202 (S301).

Upon detection of queuing of the search job, the mode determination unit 203 checks whether or not the search control unit 204 is executing the search processing (S302). If the search control unit 204 is executing the search processing, the mode determination unit 203 waits until the search processes are terminated. If the search control unit 204 is not executing the search processing or the search processes are terminated, the mode determination unit 203 dequeues the search job from the search job queue 202 (S303), and determines the type of the search processes.

If the type of the search processes is data registration (S304), the search control unit 204 executes a registration process of data (S305). If the type of the search processes is data deletion (S306), the search control unit 204 executes a deletion process of entry data (S307). If the type of the search processes is a single hit mode retrieve (S308), the search control unit 204 executes a single hit mode retrieve process (S309). If the type of the search processes is a global search mode retrieve (S310), the search control unit 204 executes a global search mode retrieve process (S311).

If the type of the search processes does not correspond to anything, the mode determination unit 203 outputs a designation error of the search processes to the search control unit 204 (S312). After termination of the process, the search control unit 204 notifies the sub-processor as a request source of the search processes of a processing result via the search result notification unit 209 (S313).

The processing sequence of the retrieving unit 122 shown in FIG. 5 is an example, and the sequence for determining the processing contents before execution of the search processes, and executing the search processes based on the determination result can be adopted.

Single Hit Mode Retrieve Process

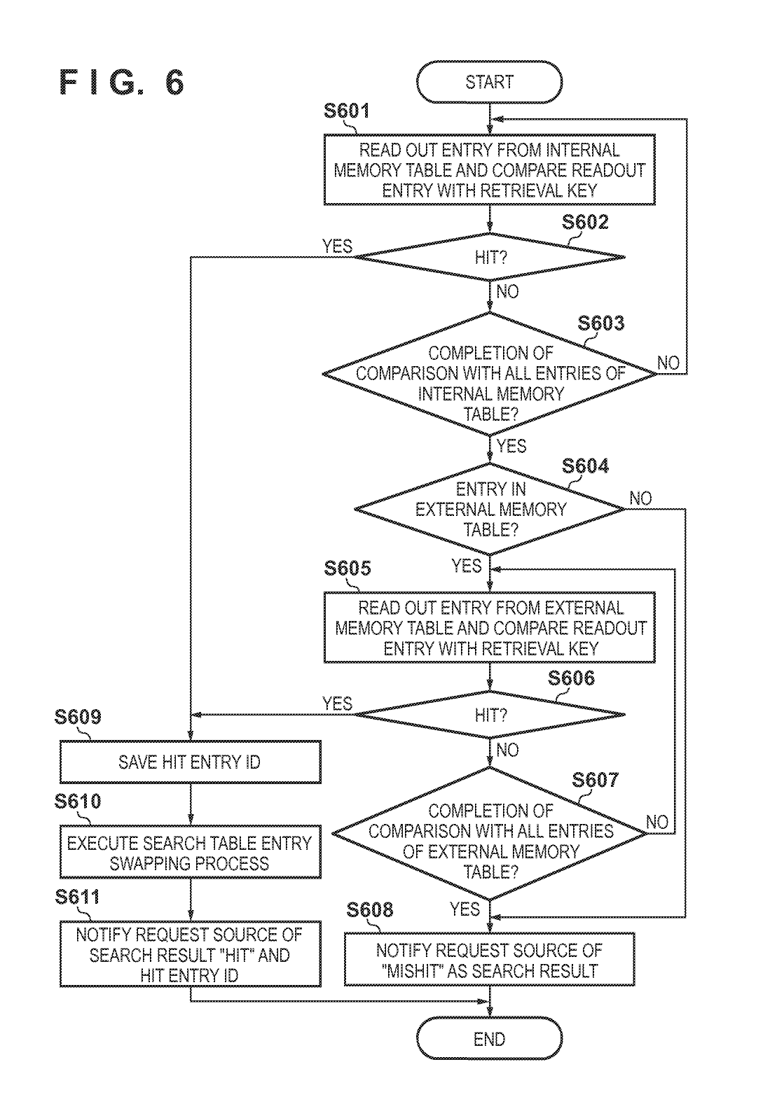

The single hit mode retrieve process (S309) will be described below with reference to the flowchart shown in FIG. 6.

The search control unit 204 controls the internal memory retrieving unit 205 to start the single hit mode retrieve process. The internal memory retrieving unit 205 reads out an entry from the internal memory table 206, and compares it with a retrieval key (S601). The internal memory retrieving unit 205 determines, as a result of comparison, whether or not a search hits (whether or not data corresponding to the retrieval key is detected) (S602). If YES in step S602, the process advances to step S609; otherwise, the process advances to step S603.

If the search does not hit, the internal memory retrieving unit 205 determines whether or not comparison with all entries in the internal memory table 206 is complete (S603). If comparison with all the entries is not complete yet, the process returns to step S601. If the internal memory retrieving unit 205 determines that comparison with all the entries is complete, the search control unit 204 terminates the retrieve process of the internal memory retrieving unit 205, and the process advances to step S604. That is, steps S601, S602, and S603 are repeated until comparison with all the entries of the internal memory table 206 is complete or an entry which hits a search is found.

If the search does not hit and comparison with all the entries of the internal memory table 206 is complete, the search control unit 204 refers to the number of registered entries to determine whether or not the external memory table 208 stores entries (S604). If the external memory table 208 does not store any entry, the process jumps to step S608.

If the external memory table 208 stores entries, the search control unit 204 controls the external memory retrieving unit 207 to start the single hit mode retrieve process. The external memory retrieving unit 207 reads out an entry from the external memory table 208, and compares it with the retrieval key (S605). The external memory retrieving unit 207 determines, as a result of comparison, whether or not a search hits (S606). If YES in step S606, the process advances to step S609; otherwise, the process advances to step S607.

If the search does not hit, the external memory retrieving unit 207 determines whether or not comparison with all entries of the external memory table 208 is complete (S607). If comparison with all the entries is not complete yet, the process returns to step S605. If the external memory retrieving unit 207 determines that comparison with all the entries is complete, the search control unit 204 terminates the retrieve process of the external memory retrieving unit 207, and the process advances to step S608. That is, steps S605, S606, and S607 are repeated until comparison with all the entries of the external memory table 208 is complete or an entry which hits a search is found.

If the external memory table 208 does not store any entry or comparison with all the entries of the external memory table 208 is complete, the search control unit 204 notifies the sub-processor as a request source of “mishit” as a search result (S608). Then, the single hit mode retrieve process is terminated.

On the other hand, if the search hits, the search control unit 204 temporarily saves a hit entry ID (S609), and executes a swapping process of search table entries (S610). Then, the search control unit 204 notifies the sub-processor as a request source of a search result “hit” and the hit entry ID (S611), thus terminating the single hit mode retrieve process.

Search Table Entry Swapping Process

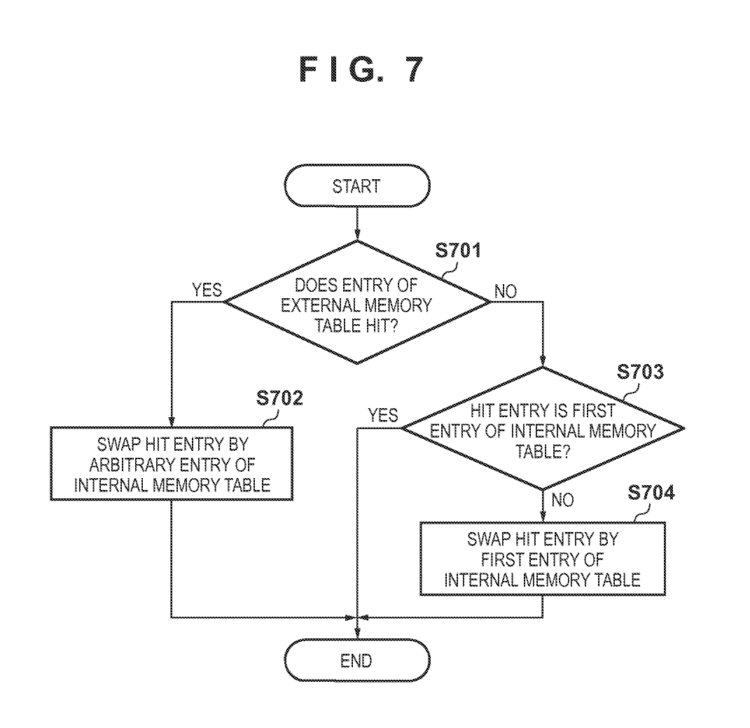

The search table entry swapping process (S610) will be described below with reference to the flowchart shown in FIG. 7.

The search control unit 204 determines whether or not an entry of the external memory table 208 hits (S701). If the entry of the external memory table 208 hits, the search control unit 204 swaps the hit entry by an arbitrary entry of the internal memory table 206 (first swapping) (S702). An arbitrary entry of the internal memory table 206 is managed in a round-robin manner except for a first entry, and an entry to be selected (an entry to be swapped) is updated every time swapping with an entry of the external memory table 208 is done.

Note that the entry to be swapped may be a first entry of the internal memory table 206 or an entry corresponding to the longest time elapsed since the last use may be selected by an arbitrary algorithm such as LRU (Least Recently Used).

On the other hand, if an entry of the internal memory table 206 hits, the search control unit 204 determines whether or not the hit entry is a first entry of the internal memory table 206 (S703). If the hit entry is the first entry, the search control unit 204 terminates the swapping process. If the hit entry is not the first entry, the search control unit 204 swaps the hit entry by the first entry of the internal memory table 206 (second swapping) (S704).

If an entry of the internal memory table 206 hits, the search table entries may not be swapped, and a next search may be started with the hit entry of the internal memory table 206. Alternatively, a search may be preferentially conducted from a plurality of entry groups in place of the first entry.

Note that the search table entry swapping process may be an arbitrary sequence which can logically configure one search table (packet process information search table) by allocating entries in the internal memory table 206 and external memory table 208.

Global Search Mode Retrieve Process

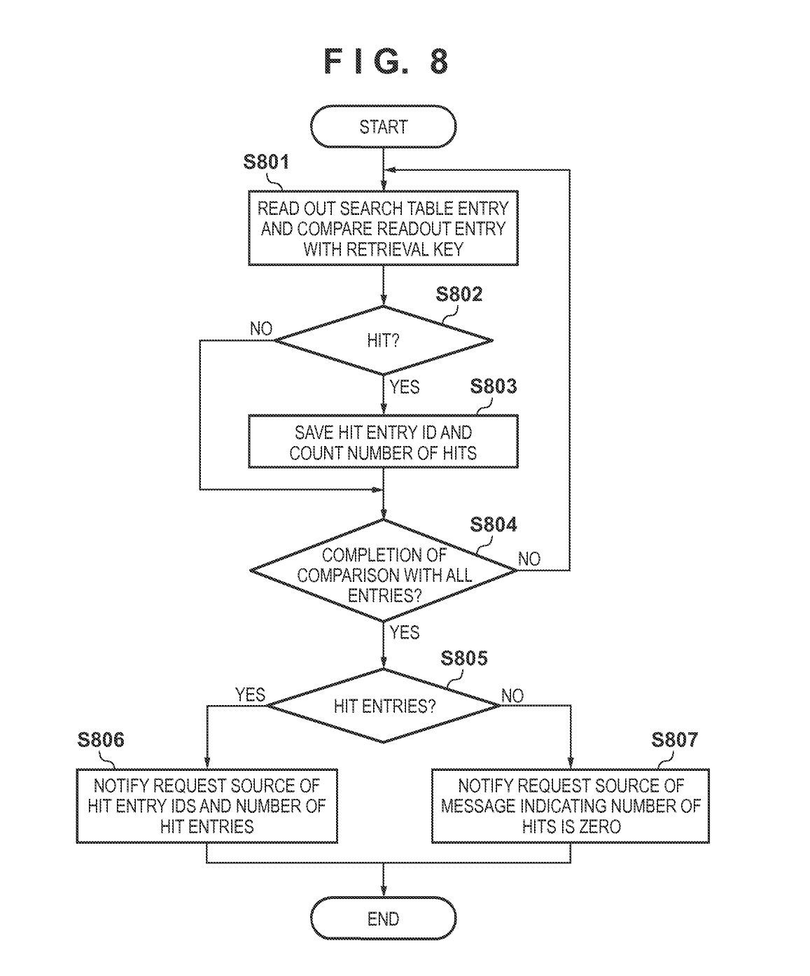

The global search mode retrieve process (S311) will be described below with reference to the flowchart shown in FIG. 8.

The search control unit 204 controls the internal memory retrieving unit 205 and external memory retrieving unit 207 to start the global search mode retrieve process. The internal memory retrieving unit 205 reads out an entry from the internal memory table 206 to compare it with a retrieval key, and the external memory retrieving unit 207 reads out an entry from the external memory table 208 to compare it with the retrieval key (S801).

The internal memory retrieving unit 205 and external memory retrieving unit 207 determine whether or not searches hit (S802). If the searches hit, the internal memory retrieving unit 205 and external memory retrieving unit 207 save a hit entry ID, and count the number of hit entries (S803). Then, the search control unit 204 determines whether or not comparison with all entries of the internal memory table 206 and that with all entries of the external memory table 208 are complete (S804). In this manner, the internal memory retrieving unit 205 and external memory retrieving unit 207 repetitively continue the processes from step S801 to step S804 in parallel until comparison with all the entries is complete.

Upon completion of comparison with all the entries, the search control unit 204 determines whether or not hit entries are found (S805). If hit entries are found, the search control unit 204 notifies the sub-processor as a request source of hit entry IDs and the number of hit entries (S806). If no hit entry is found, the search control unit 204 notifies the sub-processor as a request source of a message indicating that the number of hits is zero (S807). Then, the search control unit 204 terminates the global search mode retrieve process.

Registration Process

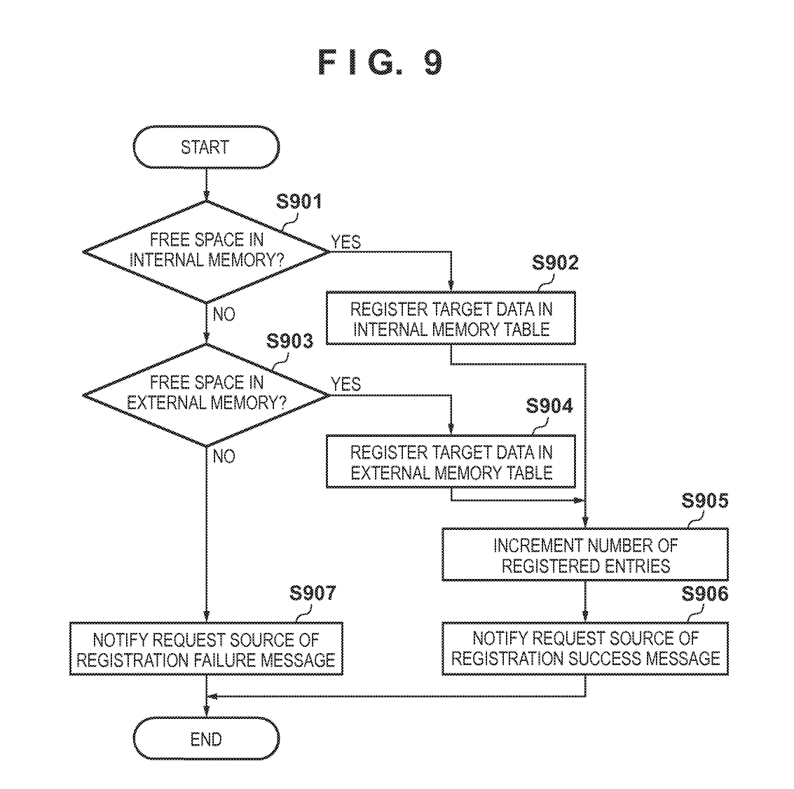

The registration process (S305) will be described below with reference to the flowchart shown in FIG. 9.

The search control unit 204 determines whether or not the internal memory which stores the internal memory table 206 has a free space (S901). If the internal memory has a free space, the search control unit 204 registers (adds) data which is requested to be registered (to be referred to as target data hereinafter) in the internal memory table 206 via the internal memory retrieving unit 205 (S902). If the internal memory does not have any free space, the search control unit 204 determines whether or not the external memory which stores the external memory table 208 has a free space (S903). If the external memory has a free space, the search control unit 204 registers (adds) the target data in the external memory table 208 via the external memory retrieving unit 207 (S904).

If the registration of the target has succeeded, the search control unit 204 increments a count value of the number of registered entries (S905), and notifies the sub-processor as a request source of a registration success message (S906). If neither the internal memory nor the external memory has any free space, the search control unit 204 notifies the sub-processor as a request source of an error notification indicating a registration failure (S907). Then, the search control unit 204 terminates the registration process.

Note that the registration process may be an arbitrary sequence which can logically configure one search table (packet process information search table) by allocating entries in the internal memory table 206 and external memory table 208.

Deletion Process

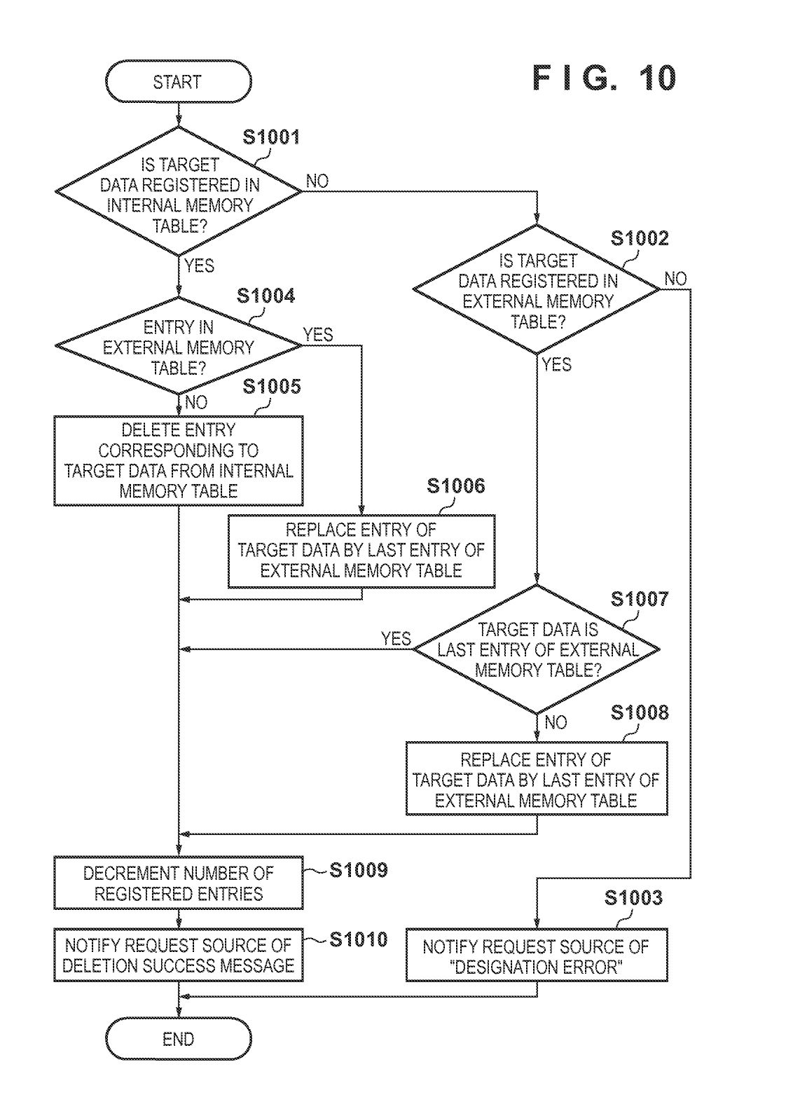

The deletion process (S307) will be described below with reference to the flowchart shown in FIG. 10.

The search control unit 204 determines, via the internal memory retrieving unit 205, whether or not entry data which is requested to be deleted (to be referred to as target data hereinafter) is registered in the internal memory table 206 (S1001). If the target data is registered in the internal memory table 206, the process advances to step S1004. On the other hand, if the target data is not registered in the internal memory table 206, the search control unit 204 determines, via the external memory retrieving unit 207, whether or not the target data is registered in the external memory table 208 (S1002). If the target data is not registered in the external memory table 208 either, the search control unit 204 notifies the sub-processor as a request source of “designation error” of the deletion process (S1003), and terminates the deletion process.

If the target data is registered in the internal memory table 206, the search control unit 204 determines whether or not the external memory table 208 stores entries (S1004). If the external memory table 208 does not store any entry, the search control unit 204 deletes an entry corresponding to the target data from the internal memory table 206 via the internal memory retrieving unit 205 (S1005). If the external memory table 208 stores entries, the search control unit 204 registers last entry data of the external memory table 208 as an entry corresponding to the target data of the internal memory table via the internal memory retrieving unit 205 and external memory retrieving unit 207 (S1006). In other words, the search control unit 204 replaces the entry of the target data by the last registered data (last entry data) of the external memory table 208.

If the target data is registered in the external memory table 208, the search control unit 204 determines, via the external memory retrieving unit 207, whether or not the target data is the last entry of the external memory table 208 (S1007). If the target data is not the last entry, the search control unit 204 registers, via the external memory retrieving unit 207, the last entry of the external memory table 208 as an entry corresponding to the target data of the external memory table 208 (S1008). In other words, the search control unit 204 replaces the entry of the target data by the last entry of the target memory table 208.

Next, the search control unit 204 decrements a count value of the number of registered entries (S1009), and notifies the sub-processor as a request source of a deletion success message (S1010), thus terminating the deletion process.

Note that the deletion process may be an arbitrary sequence which can logically configure one search table (packet process information search table) by allocating entries in the internal memory table 206 and external memory table 208.

When an entry of the internal memory table 206 is deleted, an entry of the external memory table 208 to be moved to the internal memory table 206 can be an arbitrary entry. In this case, when the last entry of the external memory table 208 is moved to an entry moved to the internal memory table 206, an efficient search can be conducted.

In this manner, the type of the requested search processes is determined prior to the search processes. In case of the global search mode retrieve, the internal and external memory search processes are executed in parallel. On the other hand, in case of the single hit mode retrieve, the search processes are sequentially executed in the order of the internal memory search process and external memory search process.

That is, when one search table is logically configured using the internal memory and external memory, a search performance drop in the global search mode is suppressed by the parallel search processes.

In the single hit mode retrieval, a search of the faster internal memory is executed in preference to the slow external memory by the sequential search processes, thus maximizing the search process performance. In this case, in the single hit mode retrieve of continuous packet in the protocol processes in which identical entries hit with a high probability, a search of the internal memory is preferentially conducted, thus reducing the number of times of execution of the process for terminating the external memory search process. As a result, unwanted processes and complicated processes can be avoided, thus avoiding complicated processes and an increase in circuit scale, and also preventing an increase in power consumption.

Also, when entries registered in the external memory are search targets of continuous packets, a delay time can be reduced, thus achieving efficient search processes.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-028860, filed Feb. 13, 2012, which is hereby incorporated by reference herein in its entirety.

What is claimed is:

1. An information processing apparatus for conducting a search process of data registered in logically one search table configured by an internal memory table allocated on an internal memory of the apparatus and an external memory table allocated on an external memory outside the apparatus, the apparatus comprising:
a first retrieving section configured to conduct a search process of data registered in the internal memory table;
a second retrieving section configured to conduct a search process of data registered in the external memory table; and
a controller configured to execute the search process by the first retrieving section and the search process by the second retrieving section in parallel or sequentially based on whether a search mode is a first search mode or a second search mode, wherein the search process in the first search mode is terminated in a case where one data is detected from the search table, and the search process in the second search mode is continued even after one data is detected from the search table.

2. The apparatus according to claim 1, wherein in a case where the search mode is the first search mode, the controller executes the search processes sequentially in an order of the search process by the first retrieving section and the search process by the second retrieving section.

3. The apparatus according to claim 1, wherein in a case where target data registered in the external memory table is detected, and the search process is terminated, the controller replaces arbitrary data registered in the internal memory table by the target data.

4. The apparatus according to claim 1, wherein in a case where target data registered in the internal memory table is detected, and the search process is terminated, the controller replaces data registered at a start position of the internal memory table by the target data.

5. The apparatus according to claim 1, wherein in a case where the search mode is the second search mode, the controller executes the search process by the first retrieving section and the search process by the second retrieving section in parallel.

6. The apparatus according to claim 1, further comprising:
an input section configured to input a processing request; and
a determiner configured to determine a type of the processing request,
wherein if the type of the processing request corresponds to data search, the controller executes the parallel or sequential search processes by the first retrieving section and the second retrieving section.

7. The apparatus according to claim 6, wherein if the type of the processing request corresponds to data registration, and in a case where the internal memory has a free space, the controller registers data to be registered in the internal memory table, and in another case where the internal memory does not have any free space, the controller registers the data to be registered in the external memory table.

8. The apparatus according to claim 6, wherein if the type of the processing request corresponds to data deletion, and in a case where data to be deleted is registered in the internal memory table, the controller replaces data in the internal memory table corresponding to the data to be deleted by data registered at a last position of the external memory table.

9. The apparatus according to claim 8, wherein in another case where the data to be deleted is registered in the external memory table, the controller replaces data in the external memory table corresponding to the data to be deleted by data registered at a last position of the external memory table.

10. A method of conducting a search process of data registered in logically one search table configured by an internal memory table allocated on an internal memory of the apparatus and an external memory table allocated on an external memory outside the apparatus, the method comprising:
using a processor to perform the steps of:
conducting a search process of data registered in the internal memory table;
conducting a search process of data registered in the external memory table; and
executing the search process in the first conducting step and the search process in the second conducting step in parallel or sequentially based on whether a search mode is a first search mode or a second search mode, wherein the search process in the first search mode is terminated in a case where one data is detected from the search table, and the search process in the second search mode is continued even after one data is detected from the search table.

11. A non-transitory computer readable medium storing a computer-executable program for causing a computer to perform a method of conducting a search process of data registered in logically one search table configured by an internal memory table allocated on an internal memory of the apparatus and an external memory table allocated on an external memory outside the apparatus, the method comprising the steps of:
conducting a search process of data registered in the internal memory table;
conducting a search process of data registered in the external memory table; and
executing the search process in the first conducting step and the search process in the second conducting step in parallel or sequentially based on whether a search mode is a first search mode or a second search mode, wherein the search process in the first search mode is terminated in a case where one data is detected from the search table, and the search process in the second search mode is continued even after one data is detected from the search table.
